(19) United States
(12) Patent Application Publication
(10) Pub. No.: US 2025/0168063 A1
(43) Pub. Date: May 22, 2025

(54) CONFIGURING VERTICAL APPLICATIONS AND SERVICES VIA ROUTE DESCRIPTORS

(71) Applicant: LENOVO (SINGAPORE) PTE LIMITED, Singapore (SG)

(72) Inventor: Roozbeh ATARIUS, La Jolla, CA (US)

(21) Appl. No.: 18/843,032

(22) PCT Filed: May 2, 2023
(86) PCT No.: PCT/IB2023/054574

§ 371 Date: Aug. 30, 2024

Related U.S. Application Data
(60) Provisional application No. 63/337,935, filed on May 3, 2022.

(51) Int. Cl. H04L 41/0806; H04L 41/0893; H04L 41/0894; H04L 41/0895

(52) U.S. Cl. CPC H04L 41/0806; H04L 41/0893; H04L 41/0894; H04L 41/0895

(57) ABSTRACT

Various aspects of the present disclosure relate to configuring vertical applications and services via route descriptors, such as network slice configurations. For example, an expanded NSCE functionality, via an NSCE server, can configure (or reconfigure) VAL applications/services via network slices or route selection descriptors (e.g., without the network slices). The NSCE server can assist in VAL reconfiguration (including slice adaptation), expanding the capabilities and use of the NSCE functionality, among other benefits.

### CROSS REFERENCE TO RELATED APPLICATIONS

This application claims priority to U.S. Provisional Patent Application No. 63/337,935, filed on May 3, 2022, entitled CONFIGURING VERTICAL APPLICATIONS AND SERVICES VIA ROUTE DESCRIPTORS, which is hereby incorporated by reference in its entirety.

### TECHNICAL FIELD

The present disclosure relates to wireless communications, and more specifically to configuring vertical applications and services supported by a vertical application layer (VAL) of a wireless communications system.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

A Service Enabler Architecture Layer (SEAL) for verticals (e.g., vertical applications or services) implements network slice capability enablement (NSCE) that supports slice reconfigurations for vertical applications and services. Slice reconfiguration can be based on an NSCE server configuration, where the NSCE server acts as an application function (AF) that influences UE Route Selection Policy (URSP) rules. The NSCE server can communicate with a Policy Control Function (PCF) node of the wireless communications system to provide guidance on route selection descriptors (e.g., single network slice selection assistance information (S-NSSAI) and data network name (DNN) information, as defined in the 3^{rd} Generation Partnership Project (3GPP) Technical Specification (TS) 24.526.

### SUMMARY

The present disclosure relates to methods, apparatuses, and systems that support configuring vertical applications and services via route descriptors, such as network slice configurations. For example, the methods, apparatuses, and systems expand an NSCE functionality, via an NSCE server, to configure (or reconfigure) VAL applications/services via network slices or route selection descriptors (e.g., without the network slices). The NSCE server can assist in VAL reconfiguration (including slice adaptation), expanding the capabilities and use of the NSCE functionality, among other benefits.

Some implementations of the method and apparatuses described herein may further include a network entity that receives a network slice configuration request for a vertical application, where the network slice configuration request includes an identifier of the vertical application, an identifier of a network route selection that includes one or more route selection descriptors of a network route for the vertical application, and a group identifier for a group of one or more user devices associated with the vertical application, triggers a network slice configuration for each user device of the group of one or more user devices associated with the vertical application, and messages a core network entity to adapt the route selection descriptors for the vertical application.

In some implementations of the method and apparatuses described herein, the network entity messages a PCF node of a wireless communications system to adapt the route selection descriptors for the vertical application.

In some implementations of the method and apparatuses described herein, the message to adapt the route selection descriptors for the vertical application includes a command to update one or more route selection policies for the vertical application when establishing a protocol data unit (PDU) session for the vertical application.

In some implementations of the method and apparatuses described herein, the network slice configuration request for the vertical application is received from a VAL client contained by one or more user devices associated with the vertical application.

In some implementations of the method and apparatuses described herein, the network slice configuration request for the vertical application is received from a VAL server that communicates with VAL clients contained by one or more user devices associated with the vertical application.

In some implementations of the method and apparatuses described herein, the network slice configuration request is part of a constrained application protocol (CoAP) message constructed by an application programming interface (API) uniform resource identifier (URI) that includes: a value identifying the vertical application, a value identifying a configuration that defines the one or route selection descriptors of the network route for the vertical application and the group identifier for the group of one or more user devices associated with the vertical application.

In some implementations of the method and apparatuses described herein, the network slice configuration request is part of a constrained application protocol (CoAP) message constructed by an application programming interface (API) uniform resource identifier (URI) that includes: a value identifying the vertical application and a value identifying a slice configuration that defines the one or route selection descriptors of the network route for the vertical application and the group identifier for the group of one or more user devices associated with the vertical application.

In some implementations of the method and apparatuses described herein, the network slice configuration request is part of a hypertext transfer protocol (HTTP) message that includes: a request uniform resource identifier (URI) that identifies an entity of the vertical application, a configuration identifier that identifies a configuration identity, a group identify that identifies the group of one or more user devices, a network route selection that includes the one or more route selection descriptors, and a configuration cause that identifies a cause of a configuration represented by the configuration identity.

In some implementations of the method and apparatuses described herein, the network slice configuration request is part of a hypertext transfer protocol (HTTP) message that includes: a request uniform resource identifier (URI) that identifies an entity of the vertical application, a slice configuration identifier that identifies a configuration identity for a network slice associated with the vertical application, a group identify that identifies the group of one or more user devices, a network route selection that includes the one or more route selection descriptors, and a configuration cause that identifies a cause of a configuration represented by the configuration identity.

In some implementations of the method and apparatuses described herein, the network entity transmits a network slice configuration response that includes information confirming the adaptation of the route selection descriptors for the vertical application.

In some implementations of the method and apparatuses described herein, the one or more route selection descriptors of the network route for the vertical application include S-NSSAI and DNN information.

Some implementations of the method and apparatuses described herein may further include a user device configured to provide, from a VAL client of the user device to a NSCE client of the user device, a vertical application service profile for a vertical application, and transmit, from the NSCE client of the user device, a network configuration request that includes the vertical application service profile to a network entity.

In some implementations of the method and apparatuses described herein, the network configuration request includes a requested network slice for the vertical application or one or more route selection descriptors of a network route for the vertical application.

In some implementations of the method and apparatuses described herein, the network configuration request includes a request to map the vertical application to a different network slice than a current network slice via which the vertical application is mapped.

### BRIEF DESCRIPTION OF THE DRAWINGS

FIG. 1 illustrates an example of a wireless communications system that supports configuring vertical applications and services in accordance with aspects of the present disclosure.

FIG. 2 illustrates an example of a diagram that supports configuring vertical applications and services using NSCE in accordance with aspects of the present disclosure.

FIGS. 3A-3B illustrate examples of diagrams that depict paths for configuring vertical applications and services using NSCE in accordance with aspects of the present disclosure.

FIG. 4 illustrates an example of a diagram that supports messaging between entities for configuring vertical applications and services using NSCE in accordance with aspects of the present disclosure.

FIG. 5 illustrates an example of a diagram that supports a resource URI structure for a constrained application protocol (CoAP) message in accordance with aspects of the present disclosure.

FIG. 6 illustrates another example of a diagram that supports messaging between entities for configuring vertical applications and services using NSCE in accordance with aspects of the present disclosure.

FIG. 7 illustrates another example of a diagram that supports a resource URI structure for a constrained application protocol (CoAP) message in accordance with aspects of the present disclosure.

FIG. 8 illustrates a flowchart of a method that supports a network entity configuring vertical applications and services using NSCE in accordance with aspects of the present disclosure.

FIG. 9 illustrates another flowchart of a method that supports a network entity configuring vertical applications and services using NSCE in accordance with aspects of the present disclosure.

FIG. 10 illustrates an example of a block diagram of a device that supports configuring vertical applications and services using NSCE in accordance with aspects of the present disclosure.

### DETAILED DESCRIPTION

While the SEAL for verticals specification describes network slice capability enablement support when configuring network slices for vertical applications, the specification is limited to slice adaptation (e.g., which is directed to adjusting route selection descriptors S-NSSAI (and possibly DNN) so VAL services/applications can be setup by establishing a right PDU session. Thus, the NSCE support is currently limited to responding to single request type, that of a slice adaptation request.

However, the NSCE can support functionality, in addition to slice adaptation operations, when providing services to vertical applications and services. Thus, the systems, method, and devices described herein provide solutions for utilizing the NSCE for different functions or operations associated with vertical applications and services (e.g., internet of things (IoT) systems, vehicle-to-everything (V2X) systems, and so on), such as vertical application and services that utilize a wireless communications system via a VAL and associated SEAL.

For example, an NSCE functionality, via an NSCE server, can configure (or reconfigure) VAL applications/services via network slices or route selection descriptors (without the network slice). Thus, the NSCE server can assist in VAL reconfiguration (including slice adaptation), expanding the capabilities and use of the NSCE functionality, among other benefits.

Aspects of the present disclosure are described in the context of a wireless communications system. Aspects of the present disclosure are further illustrated and described with reference to the following device diagrams and flowcharts that relate to configuring vertical applications and services using the NSCE functionality.

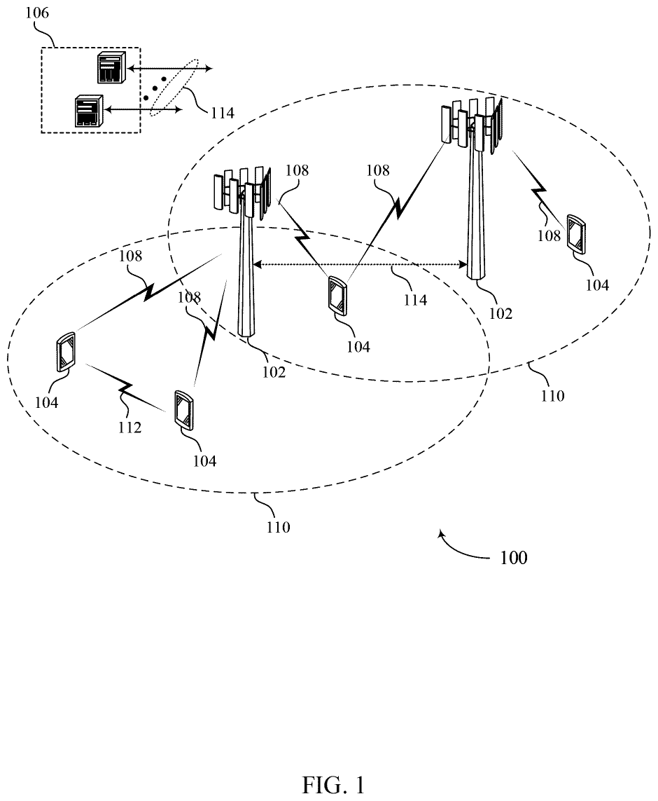

FIG. 1 illustrates an example of a wireless communications system 100 that supports configuring vertical applications and services in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 (e.g., aggregator nodes) may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wirelessly communicate over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 (e.g., sensor nodes) may be dispersed throughout a geographic region of the wireless communications system 100. A UE 104 may include or may be referred to as a mobile device, a wireless device, a remote device, a handheld device, a user device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, and/or any other device associated with a vertical application or service, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or another network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

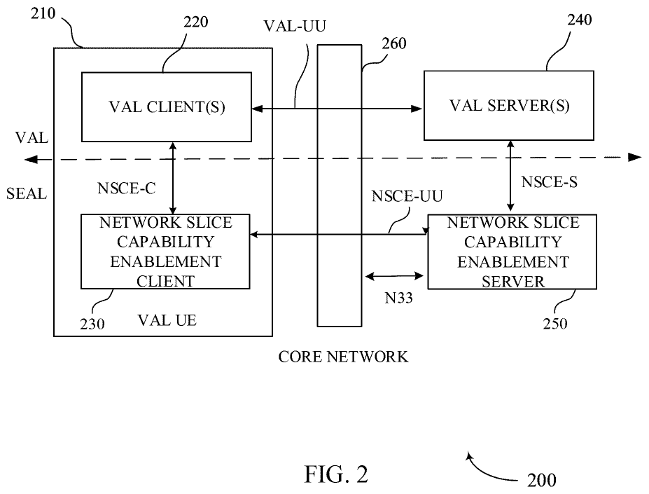

FIG. 2 illustrates an example of a diagram that supports configuring vertical applications and services using NSCE in accordance with aspects of the present disclosure. The diagram provides a functional model or system 200 for NSCE. A VAL UE 210 (e.g., IoT device, V2X device, or another VAL user device) includes a VAL client 220 and a NSCE client 230. The VAL client 220 communicates over the VAL, and the NSCE client 230 communicates over the SEAL.

The NSCE client 230 communicates with a NSCE server 250 over a NSCE-UU reference point. The NSCE client 230 provides support for NSCE functions to the VAL client 220 (or clients) over an NSCE C reference point. A VAL server 240 (or servers) communicates with the NSCE server 250 over a NSCE-S reference point. In some cases, the NSCE server 250 is deployed within a 5G system domain or core network.

The NSCE server 250, acting as an application (AF), may communicate with a 5G Core Network 260 via a network exposure function (NEF) (N33) reference point for interactions with a PCF node of the core network 260. The functional model 200 facilitates the VAL server 240 or VAL UE 210 triggering a slice configuration request, which is performed by the network entities (e.g., the NSCE server 250). However, the current specification for the functional model 200 only handles adaptation as configuration for VAL applications and services. Thus, expansion of the functional model 200, as described herein, can facilitate other configuration capabilities for the VAL UE 210 and associated vertical applications and services.

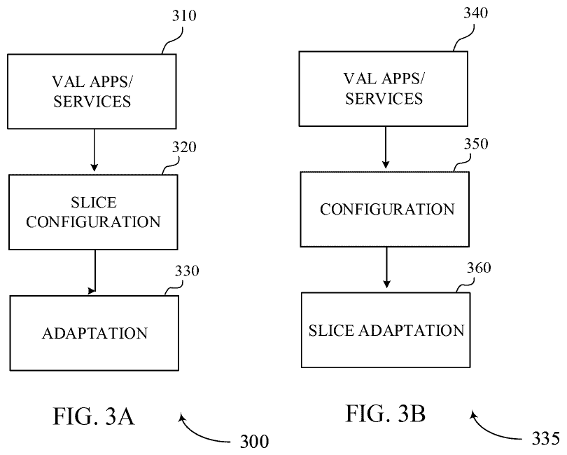

FIGS. 3A-3B illustrate examples of diagrams that depict paths for configuring vertical applications and services using NSCE in accordance with aspects of the present disclosure. The paths depict or represent expanding the functional model 200 to provide vertical applications and services with additional configuration capabilities (e.g., in addition to or along with slice adaptation).

For example, FIG. 3A depicts a first structure 300, where VAL applications/services 310 are configured/reconfigured by a network slice (or other route selection descriptors) 320. A network slice, or slice, can be, for example, an independent virtualized instance that is defined by an allocation of a subset of available network resources, such as network resources allocated to a specific vertical application or service (e.g., one slice is allocated to virtual reality applications and another slice is allocated to a V2X application). The reconfiguration of the VAL applications/services 310 utilizes an adaptation 330 of the network slice configuration (or other route selection descriptors) 320.

As another example, FIG. 3B depicts a second structure 335, where VAL applications/services 340 are configured/reconfigured by any route selection descriptor 350. The reconfiguration then utilizes a slice adaptation 360 (or other route selection descriptor, such as DNN). Thus, the reconfiguration performed by the structure 335 does not always utilize a network slice, although the slice can be utilized during the slice adaptation 360. Further details regarding the messaging procedures of structure 300 and structure 335 are described herein.

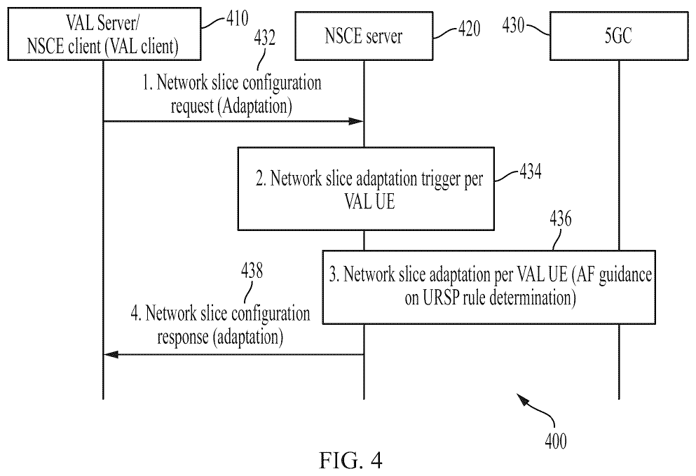

FIG. 4 illustrates an example of a diagram 400 that supports messaging between entities for configuring vertical applications and services using NSCE in accordance with aspects of the present disclosure. A VAL server 410, or an NSCE client (where the NSCE client has a new service profile for a VAL application/service by the VAL client) sends a network slice configuration request 432 to an NSCE server 420 for the VAL application (and VAL UEs within or associated with the VAL application/service).

The network slice configuration request 432 includes information that identifies a requested network slice and/or other route selection descriptors (e.g., DNN) for each VAL UE associated with the VAL application. In some cases, the request 432 includes a request to remap the VAL application/service to a different network slice and/or to other route selection descriptors.

The NSCE server 420 processes the request 432 and triggers 434 a network slice configuration for each VAL UE of the VAL application (e.g., identified via a VAL group identifier). The NSCE server 420 acts as an AF, and provides updated route selection descriptors (e.g., S-NSSAI, DNN, and so on) for each VAL UE. For example, the NSCE server 420 transmits 436 to a 5G core network node (e.g., a PCF) 430 the updated route selection descriptors via a network exposure function (NEF) as part of the AF-driven guidance for URSP determination to the 5G system. The guidance can update the route selection descriptors to indicate different sets of PDU Session information (e.g., S-NSSA, DNN, and so on) that can be associated with the vertical applications/services matching associated application data traffic.

Upon a successful of the adaptation of the route selection descriptors, the NSCE server 420 may provide a network slice configuration response 438 to the VAL server 410, providing information or verifying that the PCF completed the network slice configuration (e.g., including slice adaptation) for the requesting VAL application/service.

In some embodiments, the messaging can be performed via HTTP, such as HTTP POST messages. For example, the VAL server 410 can send the network slice configuration request 432 via HTTP, including the following information:
a Request-URI to the URI identifying the sender (the VAL server 410 or the NSCE client) appended with a VAL application/service identity and the value: “/UE-triggered-slice-configuration” if requested by the NSCE client; or “/server-triggered-slice-configuration” if requested by the VAL server;
a “Host” header field to the URI identifying the NSCE server 420 and port information; and
parameters, such as: slice configuration ID set to the value “slice adaptation”; VAL UEs of a VAL group ID; a requested slice identified as S-NSSAI; a requested DNN;
and/or a slice configuration cause.

Table 1 presents the parameters (and associated descriptions) for the network slice configuration trigger:

TABLE 1

| Parameter | Description |
|---|---|
| Slice | The slice configuration ID of the slice configuration. |
| configuration ID | |
| VAL group ID | Represents a space-separated list of VAL UE Ids |
| | within a given VAL application/service, for which |
| | a given network slice configuration trigger |
| | applies. |
| VAL service ID | The VAL service ID of the VAL application/service. |
| Requested | The new S-NSSAI which is requested. |
| S-NSSAI | |
| Requested DNN | The new DNN which is requested. |
| Slice configuration | Indicates the cause for the slice configuration. |
| cause | |

Upon receipt of the request 432, the NSCE server 420 can attempt to update the network slice for one or more of the VAL UEs associated with the VAL group ID for the VAL application/service, which is identified by the VAL service ID. The NSCE server 420 utilizes the parameters for the requested S-NSSAI and the other possible requested route selection descriptors (e.g., DNN) and slice configuration cause from the HTTP message request to update the network slice.

In some embodiments, the messaging can be performed via CoAP, such as CoAP POST messages. For example, the VAL server 410 can send the network slice configuration request 432 via CoAP, including the following information:

the CoAP URI identifying the network slice configuration for a given VAL group containing one or more VAL UEs for a given VAL application/service according to the application programming interface (API) uniform resource identifier (URI):
{apiRoot}/<apiName>/<apiVersion>/val-services/{valServiceId}/slice-configuration/{sliceConfigId},
   by setting: the “apiRoot” to the NSCE-server URI; the “valServiceId” to the value identifying the given VAL application/service; the “sliceConfigId” to the value identifying the network slice adaptation; and the “slice-configuration” to include: (1) the VAL group ID of the VAL group containing one or more VAL UEs; (2) the requested S-NSSAI; (3) other requested route selection descriptors, such as DNN; and the requested slice configuration cause; and
the “Uri-Host” and “Uri-Port” options to the URI identifying the NSCE server 420 and associated port information.

Upon receiving the request 432, the NSCE server 420 may: attempt to update the network slice for one or more VAL UEs associated with the VAL group ID for the VAL service, identified by VAL service ID by using the parameters for the requested S-NSSAI and the other possible requested route selection descriptors (e.g., DNN) and slice configuration cause from the CoAP message request; send the updated S-NSSAI and any route selection descriptor such as DNN to the PCF; and send a CoAP 2.04 response message indicating an adaptation (or an error response for failure status) of the requested network slice adaptation to the sender (the VAL server 410 or the NSCE client) of the CoAP message (e.g., CoAP POST) request.

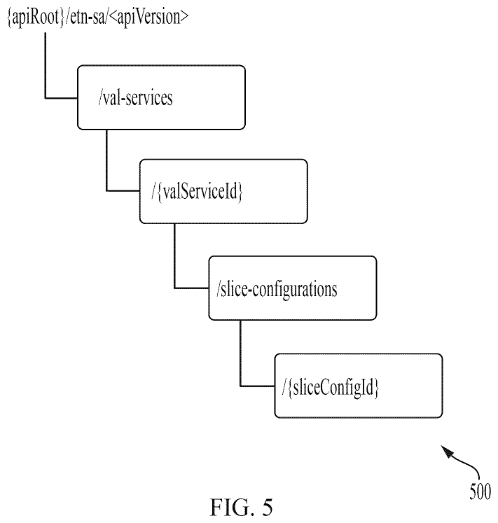

FIG. 5 illustrates an example of a diagram that supports a resource URI structure 500 for a constrained application protocol (CoAP) message in accordance with aspects of the present disclosure. Further, Table 2 provides an overview of the resources and the applicable CoAP method:

TABLE 2

| | | CoAP | |
|---|---|---|---|
| Resource name | Resource URI | method | Description |
| Slice | /val- | POST | Performs slice |
| Configuration | services/{valServiceId}/slice- | | configuration. |
| | configuration/{sliceConfigId} | | |

As depicted in Table 2, the Slice Configuration resource allows an NSCE client a specific slice configuration identified by a slice configuration ID, which may be for slice adaptation, to send a request containing: a group of one or more VAL UEs; a requested S-NSSAI; other possible requested route selection descriptors (e.g., DNN); and a requested slice configuration cause. The request is for a specific VAL application/service identified by a VAL service ID, toward an NSCE server to perform a network triggered slice adaptation for the group of one or more VAL UEs for that specific VAL service.

### The Resource URI:

{apiRoot}/etn-sa/<apiVersion>/val-services/{valServiceId}/slice-configurations/{sliceConfigId}, supports the resource URI variables defined as follows in Table 3 (and shown in FIG. 5):

TABLE 3

| | Data | |
|---|---|---|
| Name | Type | Definition |
| apiRoot | string | Described in Annex C.1 of 3GPP TS 24.546 |
| apiVersion | string | S |
| valServiceId | string | Identifier of a VAL service. |
| sliceConfigId | string | Identifier of a slice configuration |

The operation triggers a given slice adaptation performed on a group of one or more VAL UEs for a given VAL application/service, which is provided by the NSCE server 420. The CoAP message request, which may be CoAP POST request, can support the data structures shown in Table 4:

TABLE 4

| Attribute | Data | | | |
|---|---|---|---|---|
| name | type | P | Cardinality | Description |
| VAL | string | M | 1 . . . N | Represents a space-separated of |
| group | | | | VAL UE IDs within a given |
| ID | | | | VAL service, for which a |
| | | | | given network slice |
| | | | | configuration trigger applies. |
| | | | | The VAL application/service is |
| | | | | identified by the value |
| | | | | “valServiceId” and the network |
| | | | | slice configuration is identified |
| | | | | by the value “sliceConfigId” |
| | | | | which may be for slice |
| | | | | adaptation. |
| Requested | string | M | 1 | The new S-NSSAI that is |
| S-NSSAI | | | | requested. |
| Requested | string | O | 1 | The new DNN that is requested. |
| DNN | | | | |
| Slice | string | O | 1 | Indicates the cause for the slice |
| configuration | | | | configuration. |
| cause | | | | |

The CoAP message response can support the data structures shown in Table 5:

TABLE 5

| Data | | | Response | |
|---|---|---|---|---|
| type | P | Cardinality | Codes | Description |
| n/a | M | 1 | 2.04 | The slice configuration of the |
| | | | | VAL UEs with VAL group ID |
| | | | | within the VAL service identified |
| | | | | by the value “valServiceId” and |
| | | | | for the network slice |
| | | | | configuration identified by the |
| | | | | value “sliceConfigId,” which may |
| | | | | be slice adaptation, was |
| | | | | successful. |

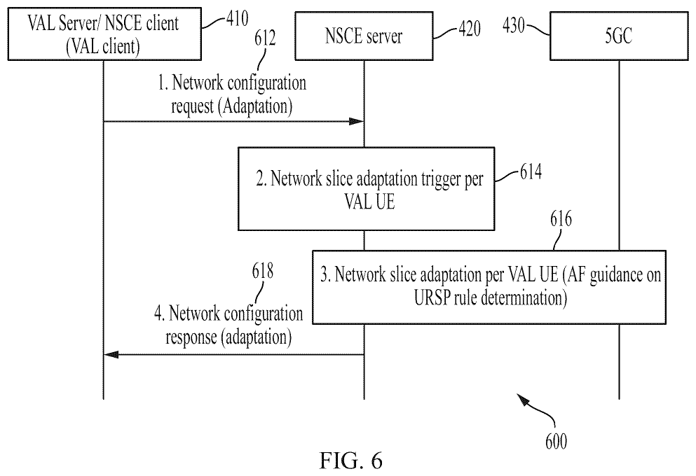

FIG. 6 illustrates another example of a diagram 600 that supports messaging between entities for configuring vertical applications and services using NSCE in accordance with aspects of the present disclosure. The VAL server 410, or the NSCE client (where the NSCE client has a new service profile for a VAL application/service by the VAL client) sends a network slice configuration request 612 to an NSCE server 420 for the VAL application (and VAL UEs within or associated with the VAL application/service).

The network slice configuration request 612 includes information that identifies a requested network slice and/or other route selection descriptors (e.g., DNN) for each VAL UE associated with the VAL application. In some cases, the request 612 includes a request to remap the VAL application/service to a different network slice and/or to other route selection descriptors.

The NSCE server 420 processes the request 612 and triggers 614 a network slice configuration for each VALUE of the VAL application (e.g., identified via a VAL group identifier). The NSCE server 420 acts as an AF, and provides updated route selection descriptors (e.g., S-NSSAI, DNN, and so on) for each VAL UE. For example, the NSCE server 420 transmits 616 to a 5G core network node (e.g., a PCF) 430 the updated route selection descriptors via a network exposure function (NEF) as part of the AF-driven guidance for URSP determination to the 5G system. The guidance can update the route selection descriptors to indicate different sets of PDU Session information (e.g., S-NSSA, DNN, and so on) that can be associated with the vertical applications/services matching associated application data traffic.

Upon a successful of the adaptation of the route selection descriptors, the NSCE server 420 may provide a network slice configuration response 618 to the VAL server 410, providing information or verifying that the PCF completed the network slice configuration (e.g., including slice adaptation) for the requesting VAL application/service.

Like the messaging described herein, in some embodiments, the messaging can be performed via HTTP, such as HTTP POST messages. For example, the VAL server 410 can send the network slice configuration request 612 via HTTP, as described herein, with a modified parameter of “configuration ID” that identifies the configuration as being independent of a slice configuration.

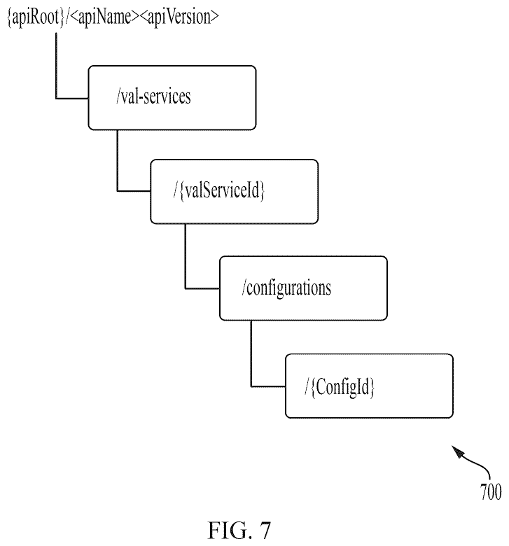

Also, in some embodiments, the messaging can be performed via CoAP, such as CoAP POST messages. For example, the VAL server 410 can send the network slice configuration request 612 via CoAP, as described herein, using a “configuration” resource instead of a “slice configuration” resource, and associated Resource URI structure. FIG. 7 illustrates another example of a diagram that supports a resource URI structure 700 for a constrained application protocol (CoAP) message in accordance with aspects of the present disclosure. Further, Table 6 provides an overview of the resources and the applicable CoAP method, showing the “configuration” resource:

TABLE 6

| Resource | | CoAP | |
|---|---|---|---|
| name | Resource URI | method | Description |
| Configuration | /val- | POST | Performs |
| | services/{valServiceId}/ | | configuration |
| | configuration/{ConfigId} | | |

Thus, as described herein, different, but related structures (structures 300 and 335) can implement NSCE to support vertical application to slice adaptation and expand beyond the slice adaptation to other configurations (including the slice adaptation). For example, the structures can leverage the various messaging procedures and implementations used for slice adaptation to cover or expand upon other configurations, among other benefits.

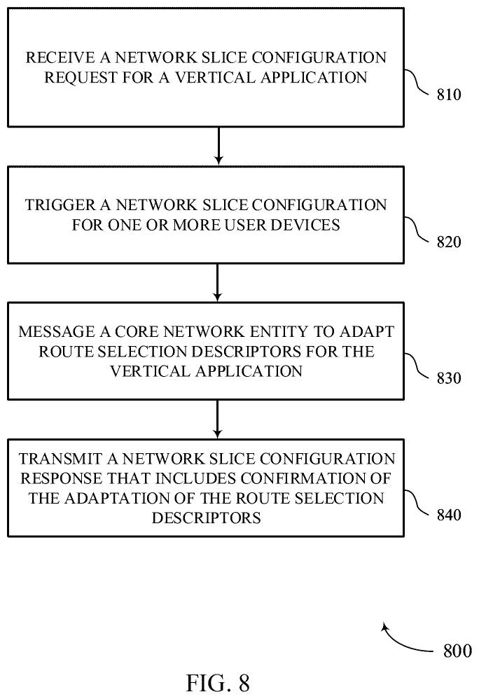

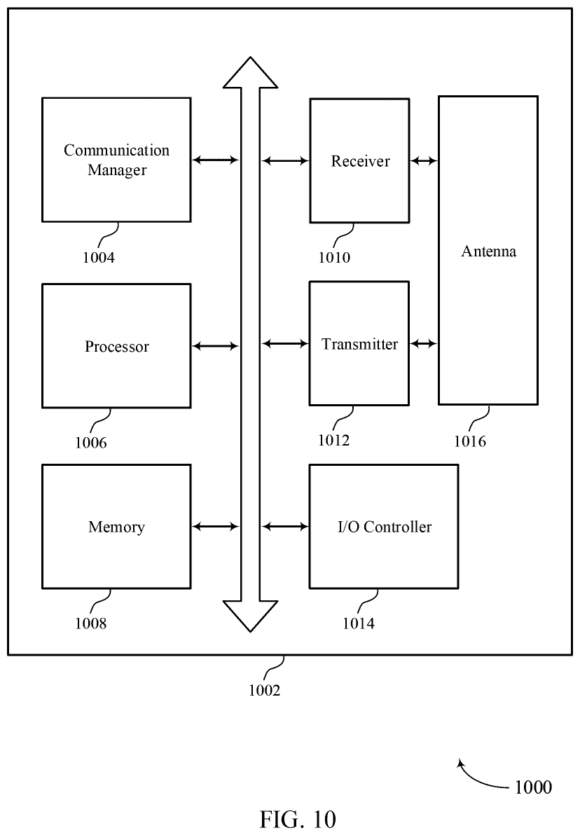

FIG. 8 illustrates a flowchart of a method 800 that supports a network entity configuring vertical applications and services using NSCE in accordance with aspects of the present disclosure. The operations of the method 800 may be implemented by a device or its components as described herein. For example, the operations of the method 800 may be performed by the device as described with reference to FIG. 10. In some implementations, the device may execute a set of instructions to control the function elements of the device to perform the described functions. Additionally, or alternatively, the device may perform aspects of the described functions using special-purpose hardware.

At 810, the method 800 may include receiving a network slice configuration request for a vertical application. For example, the NSCE server 420 can receive the request from the VAL server 410 or VAL client. The operations of 810 may be performed in accordance with examples as described herein. In some implementations, aspects of the operations of 810 may be performed by a device as described with reference to FIG. 1.

At 820, the method 800 may include triggering a network slice configuration for one or more user devices. The operations of 820 may be performed in accordance with examples as described herein. In some implementations, aspects of the operations of 820 may be performed by a device as described with reference to FIG. 1.

At 830, the method 800 may include messaging a core network entity to adapt route selection descriptors for the vertical application. The operations of 830 may be performed in accordance with examples as described herein. In some implementations, aspects of the operations of 830 may be performed by a device as described with reference to FIG. 1.

At 840, the method 800 may include transmitting a network slice configuration that includes confirmation of the adaptation of the route selection descriptors. The operations of 840 may be performed in accordance with examples as described herein. In some implementations, aspects of the operations of 840 may be performed by a device as described with reference to FIG. 1.

As described herein, the VAL server 410, or a VAL client (e.g., the VAL client 220 in tandem with the NSCE client 230 of the VAL UE 21) can generate and transmit a request to adapt a network slice for a vertical application/service associated with the VAL client.

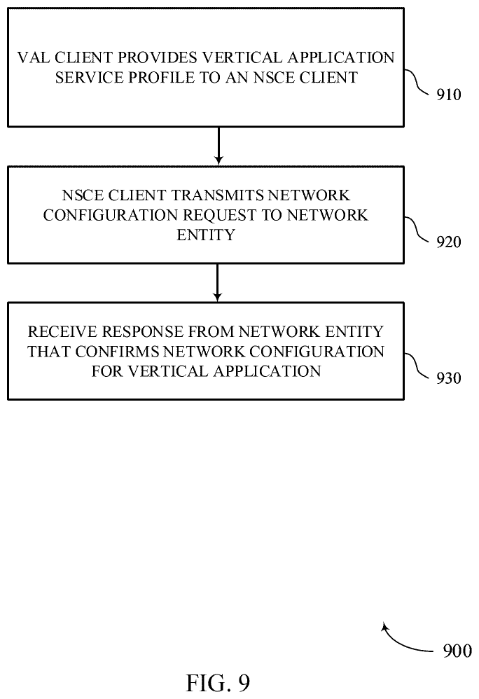

FIG. 9 illustrates another flowchart of a method 900 that supports a network entity configuring vertical applications and services using NSCE in accordance with aspects of the present disclosure. The operations of the method 900 may be implemented by a device or its components as described herein. For example, the operations of the method 900 may be performed by the device as described with reference to FIG. 10. In some implementations, the device may execute a set of instructions to control the function elements of the device to perform the described functions. Additionally, or alternatively, the device may perform aspects of the described functions using special-purpose hardware.

At 910, the method 900 may include a VAL client providing a vertical application service profile to an NSCE client. The operations of 910 may be performed in accordance with examples as described herein. In some implementations, aspects of the operations of 910 may be performed by a device as described with reference to FIG. 1.

At 920, the method 900 may include the NSCE client transmitting a network configuration request to a network entity, such as the NSCE server 420. The operations of 920 may be performed in accordance with examples as described herein. In some implementations, aspects of the operations of 920 may be performed by a device as described with reference to FIG. 1.

At 930, the method 900 may include receiving the response from the network entity that confirms the network configuration (e.g., a route or network slice adaptation) for the vertical application. The operations of 930 may be performed in accordance with examples as described herein. In some implementations, aspects of the operations of 930 may be performed by a device as described with reference to FIG. 1.

FIG. 10 illustrates an example of a block diagram 1000 of a device 1002, which supports configuring vertical applications in accordance with aspects of the present disclosure. The device 1002 may be an example of the NSCE server 250 or 420, as described herein. The device 1002 may support wireless communication with one or more base stations 102, UEs 104, or any combination thereof. The device 1002 may include components for bi-directional communications including components for transmitting and receiving communications, such as a communications manager 1004, a processor 1006, a memory 1008, a receiver 1010, transmitter 1012, and an I/O controller 1014. These components may be in electronic communication or otherwise coupled (e.g., operatively, communicatively, functionally, electronically, electrically) via one or more interfaces (e.g., buses).

The communications manager 1004, the receiver 1010, the transmitter 1012, or various combinations thereof or various components thereof may be examples of means for performing various aspects of the present disclosure as described herein. For example, the communications manager 1004, the receiver 1010, the transmitter 1012, or various combinations or components thereof may support a method for performing one or more of the functions described herein.

In some implementations, the communications manager 1004, the receiver 1010, the transmitter 1012, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1006 and the memory 1008 coupled with the processor 1006 may be configured to perform one or more of the functions described herein (e.g., by executing, by the processor 1006, instructions stored in the memory 1008).

Additionally or alternatively, in some implementations, the communications manager 1004, the receiver 1010, the transmitter 1012, or various combinations or components thereof may be implemented in code (e.g., as communications management software or firmware) executed by the processor 1006. If implemented in code executed by the processor 1006, the functions of the communications manager 1004, the receiver 1010, the transmitter 1012, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1004 may be configured to perform various operations (e.g., receiving, monitoring, transmitting) using or otherwise in cooperation with the receiver 1010, the transmitter 1012, or both. For example, the communications manager 1004 may receive information from the receiver 1010, send information to the transmitter 1012, or be integrated in combination with the receiver 1010, the transmitter 1012, or both to receive information, transmit information, or perform various other operations as described herein. Although the communications manager 1004 is illustrated as a separate component, in some implementations, one or more functions described with reference to the communications manager 1004 may be supported by or performed by the processor 1006, the memory 1008, or any combination thereof. For example, the memory 1008 may store code, which may include instructions executable by the processor 1006 to cause the device 1002 to perform various aspects of the present disclosure as described herein, or the processor 1006 and the memory 1008 may be otherwise configured to perform or support such operations.

For example, the communications manager 1004 may support wireless communication at a first device (e.g., the device 1002) in accordance with examples as disclosed herein. The communications manager 1004 may be configured as or otherwise support a means for configuring vertical application using NSCE functionality. For example, the communications manager 1004 can: receive a network slice configuration request for a vertical application, trigger a network slice configuration for each user device of a group of one or more user devices associated with the vertical application, and transmit a message to a core network entity, wherein the message includes a command to update one or more route selection policies for the vertical application when establishing a protocol data unit (PDU) session for the vertical application.

The processor 1006 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1006 may be configured to operate a memory array using a memory controller. In some other implementations, a memory controller may be integrated into the processor 1006. The processor 1006 may be configured to execute computer-readable instructions stored in a memory (e.g., the memory 1008) to cause the device 1002 to perform various functions of the present disclosure.

The memory 1008 may include random access memory (RAM) and read-only memory (ROM). The memory 1008 may store computer-readable, computer-executable code including instructions that, when executed by the processor 1006 cause the device 1002 to perform various functions described herein. The code may be stored in a non-transitory computer-readable medium such as system memory or another type of memory. In some implementations, the code may not be directly executable by the processor 1006 but may cause a computer (e.g., when compiled and executed) to perform functions described herein. In some implementations, the memory 1008 may include, among other things, a basic I/O system (BIOS) which may control basic hardware or software operation such as the interaction with peripheral components or devices.

The I/O controller 1014 may manage input and output signals for the device 1002. The I/O controller 1014 may also manage peripherals not integrated into the device 1002. In some implementations, the I/O controller 1014 may represent a physical connection or port to an external peripheral. In some implementations, the I/O controller 1014 may utilize an operating system such as iOS®, ANDROID®, MS-DOS®, MS-WINDOWS®, OS/2®, UNIX®, LINUX®, or another known operating system. In some implementations, the I/O controller 1014 may be implemented as part of a processor, such as the processor 1006. In some implementations, a user may interact with the device 1002 via the I/O controller 1014 or via hardware components controlled by the I/O controller 1014.

In some implementations, the device 1002 may include a single antenna 1016. However, in some other implementations, the device 1002 may have more than one antenna 1016, which may be capable of concurrently transmitting or receiving multiple wireless transmissions. The receiver 1010 and the transmitter 1012 may communicate bi-directionally, via the one or more antennas 1016, wired, or wireless links as described herein. For example, the receiver 1010 and the transmitter 1012 may represent a wireless transceiver and may communicate bi-directionally with another wireless transceiver. The transceiver may also include a modem to modulate the packets, to provide the modulated packets to one or more antennas 1016 for transmission, and to demodulate packets received from the one or more antennas 1016.

In addition to supporting wireless communication at a first device, such as the NSCE server 250 or 420, the communications manager 1004, when implemented as part of the UE 104, can support wireless communication at a second device in accordance with examples as disclosed herein. The communications manager 1004 may be configured as or otherwise support a means for transmitting configuration requests for vertical applications. For example, the communications manager 1004 can: provide, from a VAL client of the user device to a NSCE client of the user device, a vertical application service profile for a vertical application, and transmit, from the NSCE client of the user device, a network configuration request that includes the vertical application service profile to a network entity.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity for wireless communication, comprising:
at least one memory; and
at least one processor coupled with the at least one memory and configured to cause the network entity to:
receive a network slice configuration request for a vertical application, wherein the network slice configuration request includes:
an identifier of the vertical application;
an identifier of a network route selection that includes one or more route selection descriptors of a network route for the vertical application; and
a group identifier for a group of one or more user devices associated with the vertical application;
trigger a network slice configuration for each user device of the group of one or more user devices associated with the vertical application; and
message a core network entity to adapt the route selection descriptors for the vertical application.

2. The network entity of claim 1, wherein the at least processor is further configured to cause the network entity to:
message a policy control function (PCF) node of a wireless communications system to adapt the route selection descriptors for the vertical application.

3. The network entity of claim 1, wherein the message to adapt the route selection descriptors for the vertical application includes a command to update one or more route selection policies for the vertical application when establishing a protocol data unit (PDU) session for the vertical application.

4. The network entity of claim 1, wherein the network slice configuration request for the vertical application is received from a vertical application layer (VAL) client contained by one or more user devices associated with the vertical application.

5. The network entity of claim 1, wherein the network slice configuration request for the vertical application is received from a vertical application layer (VAL) server that communicates with VAL clients contained by one or more user devices associated with the vertical application.

6. The network entity of claim 1, wherein the network slice configuration request is part of a constrained application protocol (CoAP) message constructed by an application programming interface (API) uniform resource identifier (URI) that includes:
a value identifying the vertical application; and
a value identifying a configuration that defines the one or route selection descriptors of the network route for the vertical application and the group identifier for the group of one or more user devices associated with the vertical application.

7. The network entity of claim 1, wherein the network slice configuration request is part of a constrained application protocol (CoAP) message constructed by an application programming interface (API) uniform resource identifier (URI) includes:
a value identifying the vertical application; and
a value identifying a slice configuration that defines the one or route selection descriptors of the network route for the vertical application and the group identifier for the group of one or more user devices associated with the vertical application.

8. The network entity of claim 1, wherein the network slice configuration request is part of a hypertext transfer protocol (HTTP) message that includes:
a request uniform resource identifier (URI) that identifies an entity of the vertical application;
a configuration identifier that identifies a configuration identity;
a group identify that identifies the group of one or more user devices;
a network route selection that includes the one or more route selection descriptors; and
a configuration cause that identifies a cause of a configuration represented by the configuration identity.

9. The network entity of claim 1, wherein the network slice configuration request is part of a hypertext transfer protocol (HTTP) message that includes:
a request uniform resource identifier (URI) that identifies an entity of the vertical application;
a slice configuration identifier that identifies a configuration identity for a network slice associated with the vertical application;
a group identify that identifies the group of one or more user devices;
a network route selection that includes the one or more route selection descriptors; and
a configuration cause that identifies a cause of a configuration represented by the configuration identity.

10. The network entity of claim 1, wherein the at least one processor is further configured to cause the network entity to:
transmit a network slice configuration response that includes information confirming the adaptation of the route selection descriptors for the vertical application.

11. The network entity of claim 1, wherein the one or more route selection descriptors of the network route for the vertical application include single network slice selection assistance information (S-NSSAI) and data network name (DNN) information.

12. A method performed by a network entity, the method comprising:
receiving a network slice configuration request for a vertical application, triggering a network slice configuration for each user device of a group of one or more user devices associated with the vertical application; and
transmitting a message to a core network entity, wherein the message includes a command to update one or more route selection policies for the vertical application when establishing a protocol data unit (PDU) session for the vertical application.

13. The method of claim 12, wherein the network slice configuration request includes:
an identifier of the vertical application;
an identifier of a network route selection that includes one or more route selection descriptors of a network route for the vertical application; and
a group identifier for the group of one or more user devices associated with the vertical application.

14. The method of claim 12, wherein the message is configured to adapt one or more route selection descriptors for the vertical application.

15. The method of claim 12, the network slice configuration request is received via a constrained application protocol (CoAP) message constructed by an application programming interface (API) uniform resource identifier (URI).

16. The method of claim 12, the network slice configuration request is received via a hypertext transfer protocol (HTTP) message.

17. (canceled)

18. A user device for wireless communication, comprising:
at least one memory; and
at least one processor coupled with the at least one memory and configured to cause the user device to:
provide, from a vertical application layer (VAL) client of the user device to a network slice capability enablement (NSCE) client of the user device, a vertical application service profile for a vertical application; and
transmit, from the NSCE client of the user device, a network configuration request that includes the vertical application service profile to a network entity.

19. The user device of claim 18, wherein the network configuration request includes a requested network slice for the vertical application or one or more route selection descriptors of a network route for the vertical application.

20. The user device of claim 18, wherein the network configuration request includes a request to map the vertical application to a different network slice than a current network slice via which the vertical application is mapped.

21. A processor for wireless communication, comprising:
at least one controller coupled with the at least one memory and configured to cause the processor to:
provide, from a vertical application layer (VAL) client of the processor to a network slice capability enablement (NSCE) client of the processor a vertical application service profile for a vertical application; and
transmit, from the NSCE client of the processor, a network configuration request that includes the vertical application service profile to a network entity.
